(19) United States
(12) Patent Application Publication
(10) Pub. No.: US 2004/0012190 A1
(43) Pub. Date: Jan. 22, 2004

(54) Book with pages containing coverable apertures that superimpose images

(75) Inventor: Deborah B. D'Andrea, Akron, OH (US)

Correspondence Address: HAHN LOESER & PARKS, LLP, TWIN OAKS ESTATE, 1225 W. MARKET STREET, AKRON, OH, 44313, US

(73) Assignee: Playhouse Publishing, Inc.

(21) Appl. No.: 10/384,178

(22) Filed: Mar. 7, 2003

Related U.S. Application Data
(60) Provisional application No. 60/362,639, filed on Mar. 8, 2002.

(51) Int. Cl. B42D 1/00

(52) U.S. Cl. 281/38

(57) ABSTRACT

A book utilizing an image of subjects significant to the reader are affixed to an inside cover of the book and subsequently appear on a number of pages through an aperture on each page, which superimposes the subject in a manner completing an illustration on each page. The pages include at least one flap, which is illustrated and positionable to allow a user to cover the aperture in a manner to play peek-a-boo with the child.

### TECHNICAL FIELD

This application claims the benefit of U.S. Provisional Application No. 60/362,639 filed Mar. 8, 2002 and herein incorporated by reference. Generally, the present invention relates to books which are entertaining and which can be personalized for a child. More specifically, the present invention relates to books for children in which an image of subjects significant to the reader are affixed to an inside cover of the book and subsequently appear on a number of pages through an aperture on each page which superimposes the subject in a manner completing an illustration on each page. The pages include at least one flap which is illustrated and positionable to allow a user to cover the aperture in a manner to play peek-a-boo with the child.

### BACKGROUND

Over the years, many variations of the standard children's book have been developed. Books shaped similar to a figure discussed in the book, books made of various materials, and many other types are all well-known in the art.

Yet another variation of the standard children's book utilizes holes or apertures cut out of a number of pages in the book. Many of these books use the hole to disclose only a portion of a larger illustration on the following page, requiring the young reader to use imagination and reasoning to guess the identity of the larger illustration.

However, none of the prior art books combine the use of apertures, in conjunction with a personalized photo, in a manner that allows the user to interact with the book.

### SUMMARY

The present invention relates to a book for children in which images of subjects significant to the child may be attached to the inner surfaces of a book's front and/or back cover such that these subjects appear on each page of the book through an aperture which superimposes the subject. Each page has at least one flap, positionable to cover the aperture when the flap is completely opened, allowing the child or parent to play peek-a-boo with the image. The flap is illustrated on both sides with respective illustrations that personify the game of peek-a-boo when the flap is opened and closed.

These and other advantages of the present invention are accomplished by a book comprising a front cover with an inner and outer surface; a rear cover with an inner and outer surface; a plurality of leaves hingedly bound between the front and rear covers, each leaf having an aperture cut therein, each aperture being in registry with an aperture on the adjacent pages; an image removably affixed to the inner surface of one of the front cover and the rear cover such that at least one aperture of each page is capable of superimposing the image when the book is open; wherein the image, when superimposed, completes the design on each respective page; and a flap formed adjacent to the aperture on each page; wherein the flap is moveable to a position covering the aperture, wherein the flap, when covering the aperture, completes the design on each respective page.

### BRIEF DESCRIPTION OF THE DRAWINGS

The objects and advantages of the invention will become more readily apparent from the detailed description of preferred embodiments taken in conjunction with the drawings wherein:

FIG. 1 is a front elevational view of a book cover having an aperture therein which superimposes the image and a closed flap positioned below the aperture illustrating one embodiment utilizing the image, aperture, and peek-a-boo flap.

FIG. 2 is a top elevational view of the book of FIG. 1 shown in an open position to the back cover with an image affixed to the back cover and pages having corresponding apertures illustrating the relationship between the image and the apertures.

FIG. 3 is a top elevational view of the book of FIG. 1 shown in an open position between two adjacent pages with apertures in the pages which superimpose the image illustrating the relationship between the image and the apertures.

FIG. 4A is a front elevational view of a cover of the book of FIG. 1 illustrating a flap in a closed position.

FIG. 4B is a front elevational view of the cover of FIG. 4A with the flap shown in the open position, covering the aperture and the superimposed image.

FIG. 5A is a top elevational view of a page of the book of FIG. 1 illustrating a flap in a closed position.

FIG. 5B is a top elevational view of the cover of FIG. 4A with the flap shown in the open position, covering the aperture and the superimposed image.

### DETAILED DESCRIPTION OF THE PREFERRED EMBODIMENT

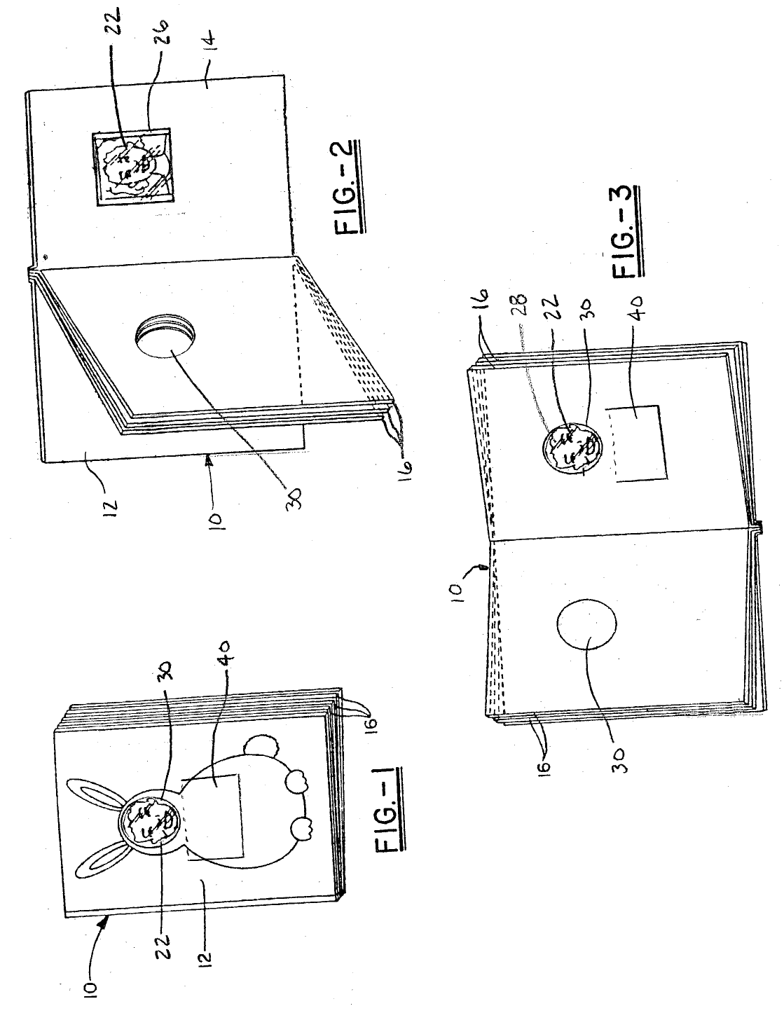

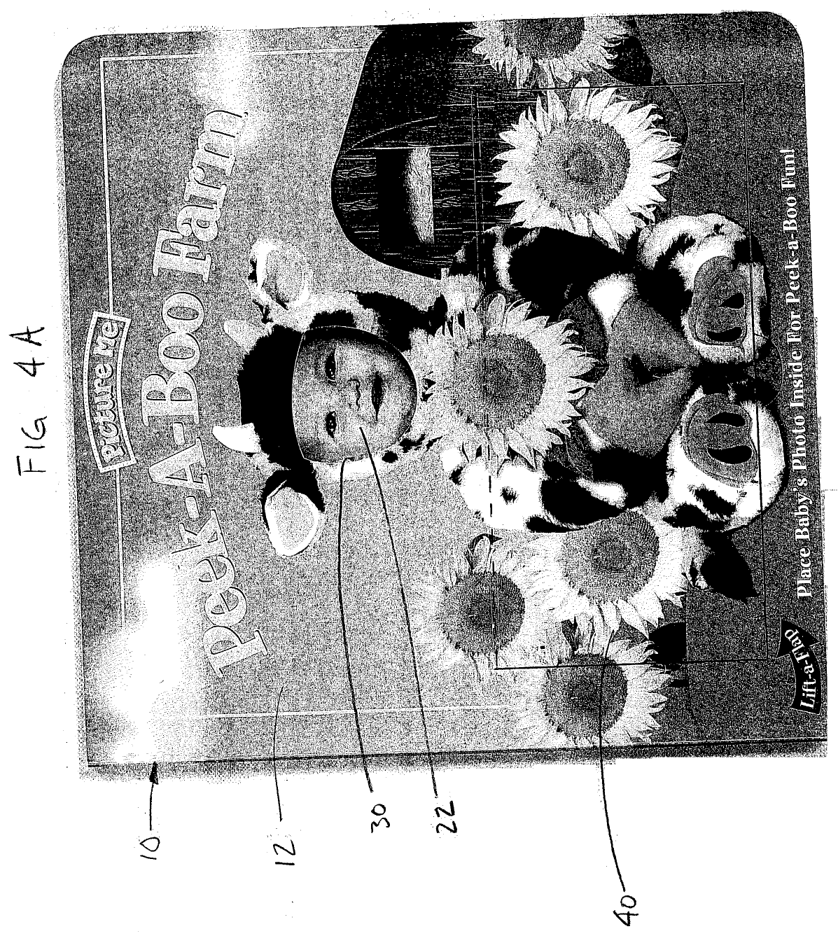

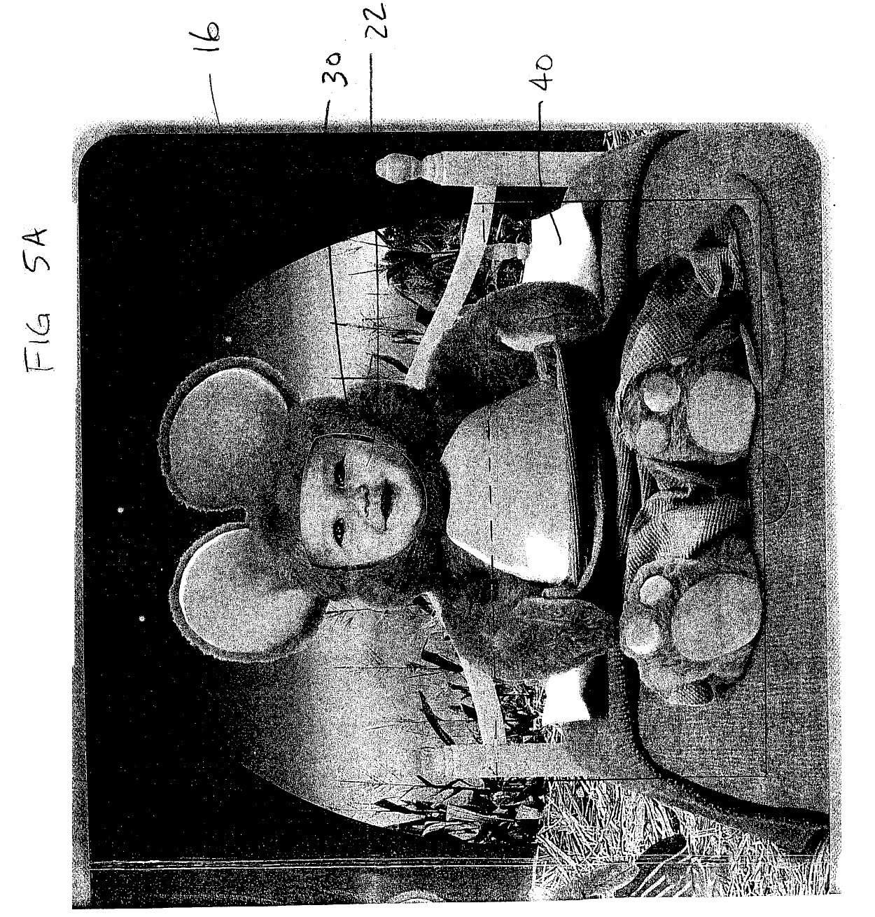

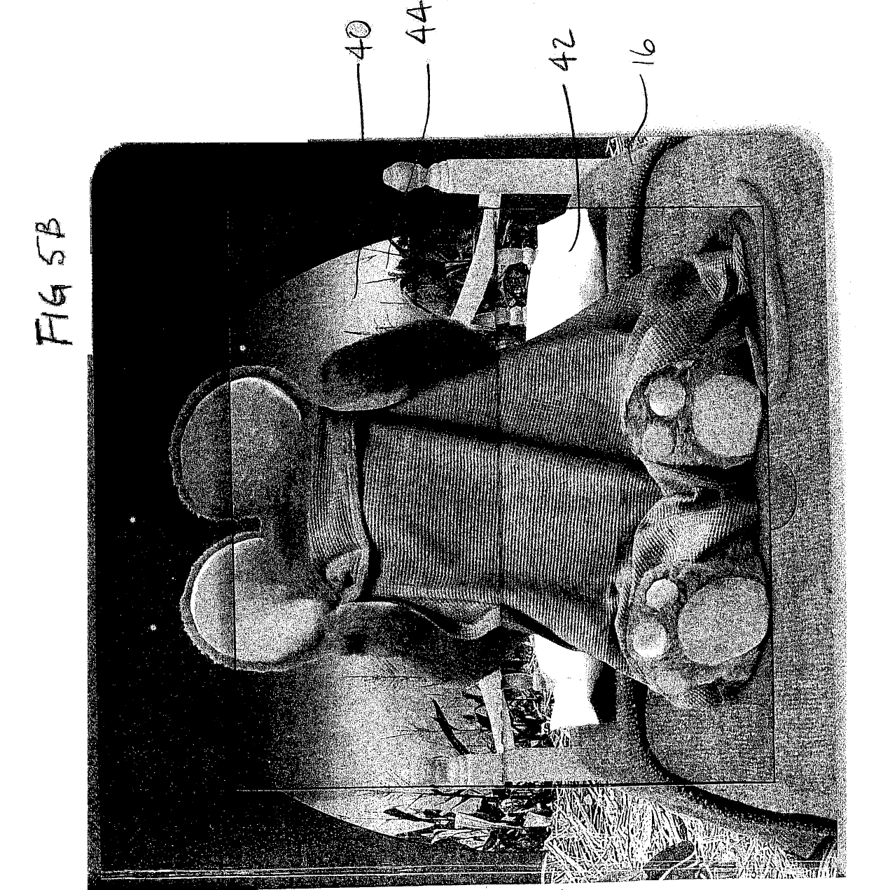

Now with reference to the present invention illustrated in the drawings, FIGS. 1-5B show a book 10 containing apertures 30 in the leaves or pages 16 which superimpose image 22 which is similar to co-owned U.S. Pat. No. 5,031,936, herein incorporated by reference. The book 10 possesses many characteristics of a standard children's book. A distinguishing feature is found in the apertures 30 cut in the pages 16 such that they are capable of superimposing an image 22 located on the rear cover 14 of the book 10, onto the pages 16 and front cover 12 of the book 10. The superimposed image 22 acts to complete the illustrations on the surface of each page 16 discussed in the page's accompanying text. Flaps 40 are shown positioned adjacent the apertures 30 in a closed position and will be discussed in greater detail below with regard to FIGS. 4A-5B.

The book 10 is made from conventional paper products known in the art. It is desirable that the front and rear covers 12 and 14 be of rigid construction for protecting the contents. Because it is contemplated that the product will be used primarily by young children, the pages may possess a more rigid structure than found in ordinary books. Likewise, the book 10 which is the subject of this invention could be manufactured out of many other materials including cloth or other suitable material and is not limited to rigid construction.

The pages 16 of the book 10 are hingedly bound between the front and rear covers 12 and 14 of the book 10. A book 10 utilizing a spiral binding may also be contemplated.

The pages 16 of the book 10 contain illustrations and/or text on the front and/or rear surfaces of each page 16. Each page 16 also contains at least one aperture 30. Each aperture 30 is in registry with corresponding apertures on adjacent pages 16. The apertures 30 on each page effectively remove a portion of the illustration on the front and rear surfaces of each page 16. The preferred embodiment shows the apertures 30 as generally removing the facial portion of the illustrations. Apertures of essentially any shape are contemplated.

The pages 16 may contain more than one aperture provided that each aperture is in registry with apertures on all adjacent pages. Furthermore, it is contemplated that additional images 22 may be affixed to the covers 12 and/or 14 such that all apertures 30 superimpose images affixed to the front and/or back covers regardless of whether the pages are viewed from the front or back surface of each page 16.

The preferred embodiment encourages the reader to supply an image 22 of subjects significant to the reader. These images may include photographs, pictures, drawings, etc., of persons, pets, fictional characters or the like. The image 22 is used to complete the illustrations printed on the front surface of each page 16. In the preferred embodiment, completion of the illustrations require the images to contain facial features. However, other embodiments contemplate many variations of possible images.

As shown in FIG. 1, the image 22 affixed to inner surface of the rear cover 14 corresponds with the apertures 30 of each page 16, and front cover 12, such that the apertures 30, when laid flat against the respective book cover, superimpose image 22. The image 22, when superimposed by the respective page 16, or cover 12, completes the illustration, and the illustration is referenced generally in the text of that page. It is noted that the inner surface of the front cover 12 could also be used as previously mentioned.

The image 22 may be affixed to the rear cover 14 of book 10 by any conventional means. The image could be permanently affixed using a variety of adhesives. However, it is contemplated that the reader or readers may wish to replace the image 22 from time to time. Therefore, the preferred embodiment shows a transparent envelope 26 with one open end affixed to each cover. Such an envelope would hold the image securely but temporarily, allowing for easy removal and replacement when desired. A three-sided framework or a series of slots cut into the rear cover for the purpose of accepting the corners of photographs or image 22 is also contemplated. When rigid paper board is used, a pocket formed in the cover, typically accessible from the top edge of the cover and having a die cut on the interior cover surface revealing the picture, can also be used.

While the book 10 encourages the reader to supply an image 22 for use with the book 10, an illustration is placed on the inside surface of the rear cover 14 to make the book functional without separate images. The illustrations are positioned so that the apertures 30 cut in pages 16 superimpose these illustrations. Supplied image 22, when supplied by the reader, would simply be affixed to the inside surface of the rear cover 14 directly over the respective illustration.

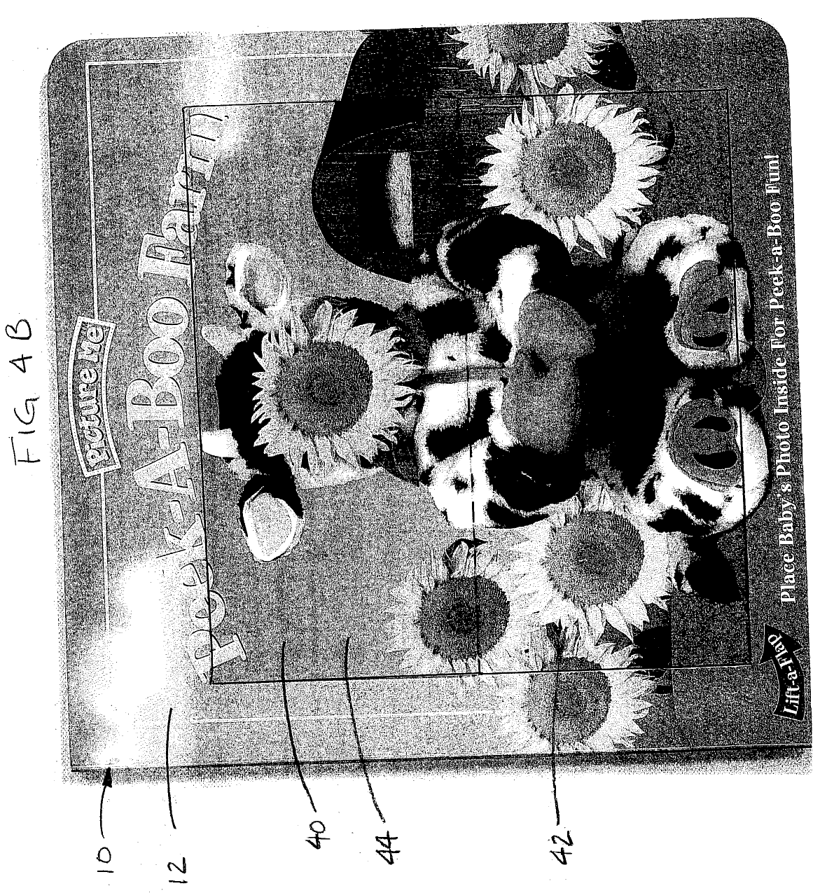

Mutually corresponding apertures 30 cut in pages 16 may be cut in identical position relative to one another or laterally adjusted slightly on each page 16 to compensate for the binding thickness. Adjustments would not necessarily be required in books containing relatively few pages. However, in books containing more than several pages, or pages of substantial thickness, such adjustment would ensure that the images were centered within the aperture 30 of each page 16. As shown in FIG. 3, the apertures 30 may be covered with a laminate material 28.

Referring now to FIGS. 4A-4B, an embodiment of the present invention is shown with an aperture 30 formed in the front cover 12 having a portion of a picture 22 positioned on an interior surface of the rear cover 14 viewable through apertures 30 in the pages 16 and front cover 12. The cover 14 has an illustration typically of a baby dressed in various animal costumes although it is not limited as such. The facial portion of the baby is provided by the picture 22 on the rear cover 14 providing a personalized illustration. Flaps 40 are shown positioned below the aperture 30 in a closed position. Referring now to FIG. 4B, when the flap 40 is opened, the aperture 30 is covered such that the portion of picture 22 is no longer visible. The area 42 initially covered by the flap 40 and the reverse side 44 of the flap 40 may also contain an illustration showing the baby dressed in the animal costume covering his/her face with an object that appeared in the uncovered illustration. This will enable the user to play peek-a-boo with the picture 22 in conjunction with the illustrations provided by flap 40.

As shown in FIGS. 5A-5B, the, interior pages 16 of book 10 may also contain flaps 40 having a similar theme. In each case, the flap 40 is located such that, when the flap 40 is opened, the flap 40 covers aperture 30 and the picture 22 previously visible through the aperture 30. The illustrations on both sides of flap 40 effectively simulate the covering of the aperture by the figure of the original illustration formed when the flap 40 was closed.

The book 10 is, ideally, purchased by a parent or relative of a small child, who supplies the image 22. The image 22 is affixed to the inner surface of the rear cover 14 on the book 10 in a manner previously discussed. The book is read to the small child by an adult or an older child. The small child, upon looking at the front cover 12 or opening the book 10, discovers image 22 significant to the small child viewable through front cover 12 and interior pages 16. The image 22 appearing through the aperture 30 completes the illustration and is generally referred to in the text. The flaps 40 on each page 16 and cover 12 are then used by the adult or older child to play peek-a-boo with the small child who may not yet be able to read. The illustrations associated with flaps 40 make the game more interesting by relating the uncovered picture to the covered picture, typically covering the face of the illustration with an object that was in the uncovered illustration as shown in FIGS. 4B and 5B.

It is thought that the reader will receive increased enjoyment when viewing illustrations incorporating an image 22 of himself/herself, or a subject familiar to the reader.

It is contemplated that variations of the invention can be made without departing from the scope of the invention. One such modification would be to position the flap 40 on the cover 12 such that the flap 40 initially covers the aperture 30 and the superimposed image 22. The user would then play peek-a-boo in reverse with the cover 12. Another modification would be to use a non-board book format and use flaps 40 that would be added to the pages and or cover. Multiple aperture 30 combinations on the covers 12, 14 and or pages 16 are also contemplated for use with the flaps 40. These and other such modifications are contemplated as part of the scope of the present invention, and the subject invention is not to be limited by the specific apparatus or method of operation described and/or depicted by the drawings, nor is the invention to be limited by the specific materials and components identified and described herein.

What is claimed is:

1. A book comprising:
a front cover with an inner and outer surface;
a rear cover with an inner and outer surface;
a plurality of leaves hingedly bound between the front and rear covers, each leaf having an aperture cut therein, each aperture being in registry with an aperture on the adjacent pages;
an image removably affixed to the inner surface of one of the front cover and the rear cover such that at least one aperture of each page is capable of superimposing the image when the book is open;
wherein the image, when superimposed, completes the design on each respective page; and
a flap formed adjacent to the aperture on each page; wherein the flap is moveable to a position covering the aperture, wherein the flap, when covering the aperture, completes the design on each respective page.

2. The book of claim 1 wherein the flap is of any geometric shape.

3. The book of claim 1 wherein each flap is cut partially through each page, wherein when the flap is moved to a position covering the aperture, an interior page surface is revealed, wherein the interior page surface completes the design on each respective page.

4. The book of claim 1 wherein the flaps are cut such that each flap is centrally superimposed over the image when the flap is covering the aperture.

5. The book of claim 1 wherein the flap is formed initially over the aperture such that the flap can be removed from covering the aperture and revealing the superimposed image.

6. The book of claim 1 wherein one of the front cover and the rear cover has an aperture cut therein, wherein the cover aperture is in registry with the apertures on the pages.

7. The book of claim 6 further comprising a cover flap formed on the outer surface of one of the front cover and the rear cover.

8. The book of claim 7 wherein the cover flap is positioned adjacent to the cover aperture such that the cover flap is moveable to a position covering the cover aperture, wherein the cover flap, when covering the cover aperture, completes the design on the outer surface of one of the front cover and the rear cover.

9. The book of claim 7 wherein the cover flap is of any geometric shape.

10. The book of claim 7 wherein the cover flap is cut partially through one of the front cover and the rear cover, wherein when the cover flap is moved to a position covering the cover aperture, an interior cover surface is revealed, wherein the interior cover surface completes the design on one of the front cover and the rear cover.

11. The book of claim 1 wherein one of the front cover and the rear cover has an aperture cut on an outer surface thereof.

12. The book of claim 11 further comprising an image removably affixed between the outer surface and the inner surface of one of the front cover and the rear cover such that the cover aperture superimposes the cover image.

13. The book of claim 12 further comprising a cover flap formed on the outer surface of one of the front cover and the rear cover.

14. The book of claim 13 wherein the cover flap is positioned adjacent to the cover aperture such that the cover flap is moveable to a position covering the cover aperture, wherein the cover flap, when covering the cover aperture, completes the design on the outer surface of one of the front cover and the rear cover.

15. The book of claim 13 wherein the cover flap is cut partially through one of the front cover and the rear cover, wherein when the cover flap is moved to a position covering the cover aperture, an interior cover surface is revealed, wherein the interior cover surface completes the design on one of the front cover and the rear cover.

16. A book comprising:
a front cover and a rear cover;
a plurality of leaves hingedly bound between the front and rear covers, each leaf having an illustration thereon, each leaf having an aperture cut therein, each aperture being in registry with an aperture on the adjacent leaves;
an image removably affixed to the inner surface of one of the front cover and the rear cover such that the aperture of each leaf is capable of superimposing the image when the book is open;
wherein the image, when superimposed, completes the illustration on each respective leaf;
a flap having an outer surface and an inner surface, the flap formed adjacent to the aperture on each page; wherein the flap is moveable to a position having the inner flap surface covering the aperture, wherein the inner flap surface, when covering the aperture, completes the illustration on each respective page.

17. The book of claim 16 wherein when the flap is moved to a position covering the aperture, an interior leaf surface is revealed, wherein the interior leaf surface completes the illustration on the leaf.

18. A book comprising:
a front cover and a rear cover;
a plurality of leaves hingedly bound between the front and rear covers, each leaf having an illustration thereon, each leaf having an aperture cut therein, each aperture being in registry with an aperture on the adjacent leaves;
an image removably affixed to the inner surface of one of the front cover and the rear cover such that the aperture of each leaf is capable of superimposing the image when the book is open;
wherein the image, when superimposed, completes the illustration on each respective leaf;
a flap cut partially through each leaf having an outer flap surface and an inner flap surface, the flap formed adjacent to the aperture on each page; wherein the flap is moveable to a position having the inner flap surface covering the aperture and exposing an interior leaf surface, wherein the inner flap surface, when covering the aperture, and the interior leaf surface, complete the illustration on each respective leaf.

19. The book of claim 18 wherein one of the front cover and the rear cover has an aperture cut on an illustrated outer surface thereof and further comprising an image removably affixed between the outer surface and the inner surface of one of the front cover and the rear cover such that the cover aperture superimposes the cover image and a cover flap formed on the outer surface of one of the front cover and the rear cover positioned adjacent to the cover aperture such that the cover flap is moveable to a position covering the cover aperture, wherein the cover flap, when covering the cover aperture, completes the illustration on the outer surface of one of the front cover and the rear cover.

20. The book of claim 18 wherein the flap is of any geometric shape.
